(19) United States
(12) Patent Application Publication
(10) Pub. No.: US 2017/0184211 A1
(43) Pub. Date: Jun. 29, 2017

(54) ELECTRONIC SOLENOID AIR VENT

(71) Applicants: Jong Bae PARK, Busan (KR); KOREA VALVE CONTROL, Seoul (KR)

(72) Inventors: Jong Bae PARK, Busan (KR); Eun Yi HUH, Anyang-si, Gyeonggi-do (KR)

(73) Assignees: KOREA VALVE CONTROL, Seoul (KR); Jong Bae PARK, Busan (KR)

(21) Appl. No.: 15/313,973

(22) PCT Filed: Jun. 11, 2015
(86) PCT No.: PCT/KR2015/005880

§ 371 Date: Nov. 25, 2016

(30) Foreign Application Priority Data
Jun. 11, 2014 (KR) 10-2014-0070833

(51) Int. Cl. F16K 24/04; F16K 31/20; F16K 31/06

(52) U.S. Cl. CPC F16K 24/042; F16K 31/0644; F16K 31/20

(57) ABSTRACT

An electronic solenoid air vent according to an embodiment of the present invention comprises: a nozzle for discharging the air in the air vent to the outside; and a nozzle shut-off for controlling the opening and closing of the nozzle, wherein the nozzle shut-off includes a magnet and a solenoid which spaces the magnet apart from the nozzle in response to the volume of the air in the air vent.

### TECHNICAL FIELD

The present invention relates to an electronic solenoid air vent, and more particularly, to an electronic solenoid air vent which removes air in a fluid circulating in a pipe when the fluid is moving so that the inside of the pipe is prevented from being corroded, noise and vibration decrease, and efficiency is improved due to an increase in a speed of the moving fluid.

### BACKGROUND ART

A boiler is an apparatus which is used for heating by heating a heat medium using heat generated with a fuel such as gas, petroleum, electricity, or the like, and water, air, or the like is used as a material of the heat medium of the boiler, and water is the most commonly used material. Water contracts and expands its volume according to a temperature change, and when water is heated, the water and oxygen are separated and the water and an air bubble move in a pipe. FIG. 1 is a schematic diagram illustrating a structure of a conventional boiler, and the conventional boiler includes a heat exchanger 10 installed in the boiler, a water supplying pipe 20 and a drainage pipe 30 connected to and installed at the heat exchanger 10, a heat pipe 40 through which a heat-exchanged heating water flows, and a pressure-type expansion tank 50 connected to and installed on a path of the heat pipe 40.

Further, an air vent or an air arrester is installed at a place at which heating water is supplied from the boiler to the heat pipe (a supply pipe) 40 so that heating water from which air is removed is supplied to increase efficiency. When air is not fully removed from heating water, many problems occur such as air filling the heat pipe 40 so that noise and a resistance to a flow of water due to an air pocket (a big air bubble) are generated, heat efficiency decreases, and the like. Therefore, air in the heat pipe 40 should always be discharged, and since a conventional air vent uses a method using a float, there is a problem in that air and water are mixed and output from an outlet, or a problem in that secondary damage is generated because of a nozzle being blocked by a foreign material due to a small hole. Therefore, the conventional air vent cannot perform an inherent function of the air vent because the nozzle is blocked, and anxiety of whether water will be output occurs.

### Technical Problem

The present invention is directed to providing an electronic solenoid air vent in which an electronic solenoid is installed in the air vent, a nozzle is normally always closed, and the solenoid operates and the nozzle is opened only when air fills the air vent, and therefore water is not output and only air is discharged.

Further, the present invention is directed to providing an electronic solenoid air vent capable of checking and managing data related to the air discharged to the outside of the air vent.

### Technical Solution

The electronic solenoid air vent according to embodiments of the invention includes a nozzle for discharging air in an air vent to the outside, and a nozzle shut-off configured to control opening and closing of the nozzle, and the nozzle shut-off includes a magnet and a solenoid which spaces the magnet apart from the nozzle in response to a volume of air in the air vent.

### Advantageous Effects

The air vent according to embodiments of the present invention opens a hole only when air having an amount of a predetermined range or more fills the air vent by an operation of a solenoid, electronically discharges the air, and thus heating pipes are prevented from being corroded, noise and vibration decrease, and thermal efficiency can be improved.

Further, the air vent according to embodiments of the present invention can check and manage data related to air discharged to the outside of the air vent.

### BRIEF DESCRIPTION OF DRAWINGS

FIG. 1 is a schematic diagram illustrating a structure of a conventional boiler.

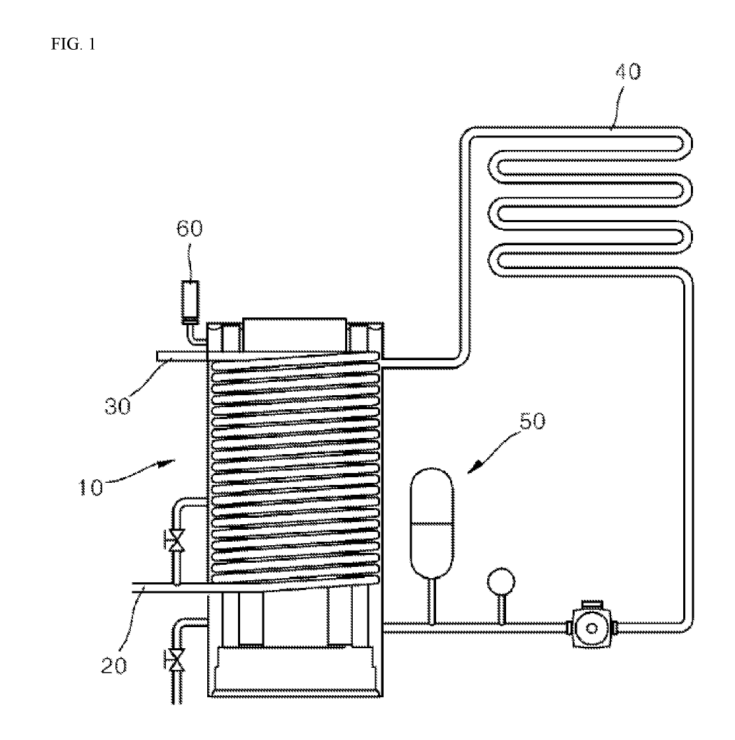

FIG. 2 is a side cross-sectional view illustrating a structure of an air vent according to an embodiment of the invention.

FIG. 3 is a side cross-sectional view illustrating components of the air vent according to the embodiment of the invention.

### MODE FOR INVENTION

The terminology used in the present invention is used only to describe embodiments of the inventive concept and is not intended to limit the scope of the inventive concept. Further, the terminology used in the present invention is to be interpreted as is customary in the art to which this inventive concept belongs unless defined otherwise. It should be further understood that terms in common usage should also be interpreted as is customary in the relevant art and not in an idealized or overly formal sense unless expressly so defined herein. Further, when the terminology used in the present invention is a wrong technical terminology which may not exactly express the concept of the present invention, it should be understood that the technical terminology is substituted by the terminology which those skilled in the art may understand. Further, the terminology used in the present invention should be interpreted according to that defined in the dictionary or according to the context, and is not to be interpreted in an overly reduced meaning.

Further, elements of the inventive concept referred to in the singular may number one or more unless clearly indicated otherwise in context. It should be further understood that the terms “comprises,” “comprising,” “includes,” and/or “including,” when used herein, specify the presence of stated features, items, steps, operations, elements, and/or components but do not preclude the presence or addition of one or more other features, items, steps, operations, elements, components, and/or groups thereof.

It should be understood that, although the terms “first,” “second,” and the like may be used herein to describe various components, these components are not to be limited by these terms. These terms are only used to distinguish one component from another component. Thus, a first component discussed below could be termed a second component and a second component discussed below could be termed a first component without departing from the teachings of the present inventive concept.

Hereinafter, preferred embodiments will be described with reference to the attached drawings, and the same or similar elements regardless of drawing numbers will be given the same reference numbers, and overlapping descriptions thereof will be omitted.

Further, when it is determined that a detailed description of well-known technology unnecessarily obscures the subject matter of the present invention in the description of the embodiments of the present invention, the detailed description will be omitted. Further, the attached drawings are only for easily understanding concepts of the present invention, and the present invention is not to be construed as limited by the attached drawings.

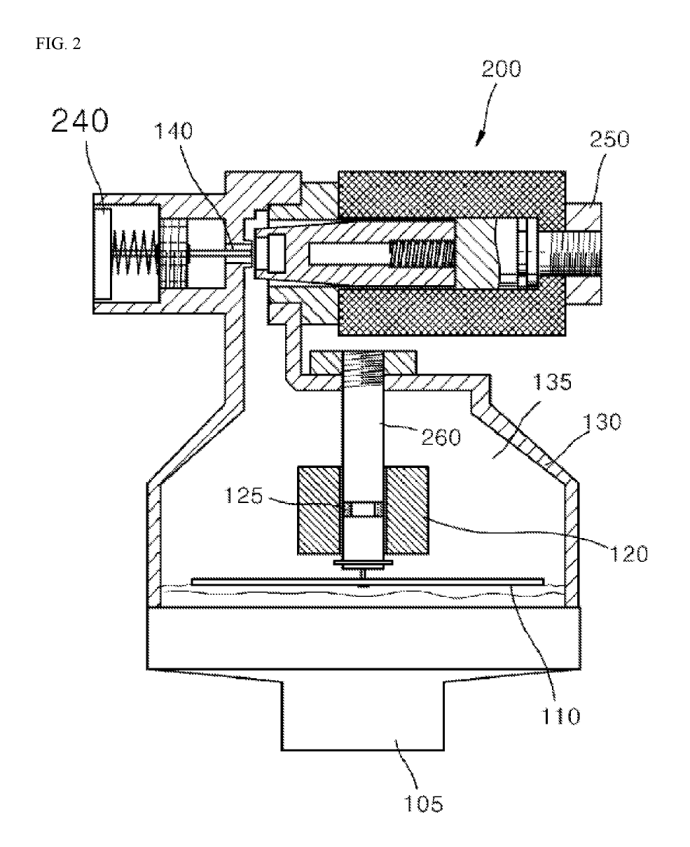

FIG. 2 is a side cross-sectional view illustrating a structure of an air vent according to an embodiment of the invention. As shown in the drawing, an air vent 100 according to the embodiment of the invention includes a connection tube 105, a separating sheet 110, an floater 120 disposed at an inside 135 of the air vent 100 and including a magnet therein, a lead switch 125, and a nozzle shut-off 200.

As shown in the drawing, the air vent 100 may be horizontally disposed, and the lead switch 125 is built into a movement shaft and senses a water level as a height of the floater 120 (a magnet) when the floater 120 moves up and down.

The connection tube 105 may be directly connected to a heater pipe, may be indirectly connected to the heater pipe by being connected to a gas separator of a heat supplying pipe and to a separator (not shown) for collecting air.

A side surface 130 of the air vent 100 may be formed to have a pyramid shape in which a cross-section thereof narrows toward an upper portion, but is not limited thereto.

The floater 120 is disposed at the inside 135 of the air vent 100. The floater 120 may be formed of a material which has a density less than water and greater than air, but is not limited thereto. The floater 120 moves up and down on the basis of a movement shaft 260 and floats because of buoyancy.

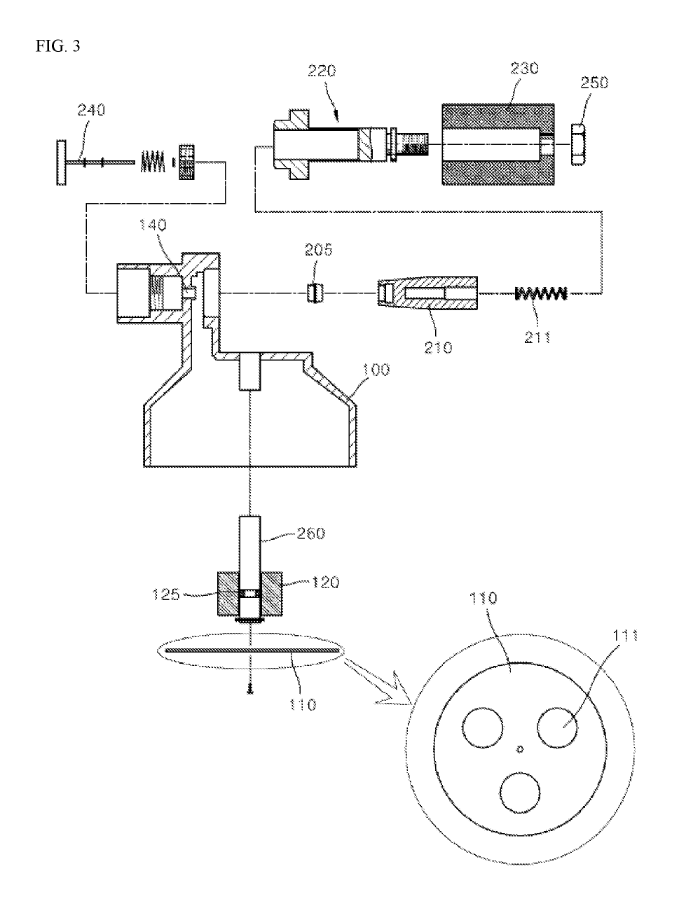

When air fills the inside 135 of the air vent 100, the floater 120 moves down by as much as a volume of the air. When the floater 120 moves down to a lower level than a predetermined height, a solenoid 230 operates and the air in the inside 135 of the air vent 100 is discharged to the outside through a nozzle 140. An operation of the nozzle shut-off 200 will be described in detail with reference to FIG. 3.

FIG. 3 is a side cross-sectional view illustrating components of the air vent according to the embodiment of the invention. Drawing symbols are omitted for the same elements as those in FIG. 2.

The nozzle shut-off 200 includes a rubber packing 205, a magnet 210, a spring 211, a cylinder 220, and the solenoid 230 on which a coil is wound. The air vent 100 includes the floater 120 which operates the lead switch 125 and a power supply (not shown) which supplies driving power, and the power supply may be formed with common-use electricity (AC) or a secondary battery (DC).

As shown in the drawing, the rubber packing 205 is connected to one end of the magnet 210, and an elastic member 211 is connected to the other end of the magnet 210. For example, the elastic member 211 may be a spring. A nut 250 that fixes the cylinder 220 and the solenoid 230 is included in the nozzle shut-off 200.

The rubber packing 205 discharges air in the inside of the air vent 100 to the outside when the solenoid 230 is operated and attracts the magnet 210 inserted into the cylinder 220 with intensity equal to or greater than an elasticity of the elastic member 211, and the rubber packing 205 comes into contact with the nozzle 140 and a closed state is maintained due to the elasticity of the elastic member 211 when the solenoid 230 is not operated.

The floater 120 is formed of a material which has a density less than water and is in contact with a surface of water. As shown in the drawing, at least one hole 111 is formed in the separating sheet 110 to pass through the separating sheet 110. Stability and reliability of operation can be enhanced by preventing the surface of water from abruptly changing through the separating sheet 110 in which holes 111 are formed. The holes 111 may be formed with an area of a half of the whole area of the separating sheet 110 or less.

As described in the above, when water fills the inside 135 of the air vent 100, a distance between the floater 120 and the lead switch 125 of the movement shaft 260 becomes large, the lead switch 125 is turned off, and the solenoid 230 is not operated. Accordingly, the rubber packing 205 comes into contact with the nozzle 140 due to the elasticity of the elastic member 211 connected to the other end of the magnet 210, and the inside 135 of the air vent 100 is closed. That is, air is not input to the inside 135 of the air vent 100, and the air in the inside 135 of the air vent 100 is not discharged to the outside.

When air fills the inside 135 of the air vent 100, the floater 120 moves down by as much as a volume of the air. Further, as the floater 120 moves down, the lead switch 125 disposed in the movement shaft 260 of the floater 120 is operated. When the floater 120 moves down to a lower level than the predetermined height, a position of the floater 120 (a magnet) nears the lead switch 125, the lead switch 125 of the movement shaft 260 of the floater 120 is turned on, and the solenoid 230 is operated. That is, power is supplied to the solenoid 230, and the solenoid 230 attracts the magnet 210 with intensity equal to or greater than the elasticity of the elastic member 211.

Accordingly, the rubber packing 205 connected to the one end of the magnet 210 is spaced apart from the nozzle 140, and the inside 135 of the air vent 100 is opened. That is, the air in the inside 135 of the air vent 100 is discharged to the outside through the nozzle 140.

Since the air in the inside 135 of the air vent 100 is discharged to the outside through the nozzle 140, the air decreases, and the inside 135 of the air vent 100 is filled with water by water pressure. Therefore, when the floater 120 moves up again, the lead switch 125, which serves as a switch, is turned off and the power supplied to the solenoid 230 is shut-off, and therefore the rubber packing 205 comes into contact with the nozzle 140 due to the elasticity of the elastic member 211 connected to the other end of the magnet 210 and the inside 135 of the air vent 100 is closed.

An air discharge manual button 240 is formed at one side of the nozzle 140. The air discharge manual button 240 is a device which may manually and forcibly discharge air in the air vent 100 that is always closed. When the air discharge manual button 240 is installed at the entrance thereof and pressed, the magnet 210 is forcibly moved back, and air in the inside 135 of the air vent 100 may be discharged to the outside. Since an elastic member is connected to the air discharge manual button 240, air in the inside 135 of the air vent 100 may be discharged to the outside only when the air discharge manual button 240 is pressed.

Further, a data storage unit (not shown) may be formed in the air vent 100. The data storage unit may store information on an operation of the solenoid, that is, information of a volume of air discharged to the outside. Specifically, the data storage unit may store information including an operation frequency of the solenoid per hour, an operation time, a volume of air discharged per operation time, and the like, and may transmit related information to the outside through a network. Therefore, information on a failure or non-failure and a discharge amount of air may be stored and checked, which may contribute to automation.

As the air in the inside 135 of the air vent 100 may be rapidly discharged to the outside by the structure described above, thermal efficiency of a boiler can be improved.

For the embodiments described above, those skilled in the art should readily appreciate that many modifications are possible without materially departing from an essential property of the present invention. Accordingly, embodiments disclosed in the present invention are not for limiting the concept of the present invention, but for describing the present invention, and the scope of the inventive concept is not limited by these embodiments. The scope of the present invention should be construed by the appended claims, and all the inventive concepts in the equivalent scope should be construed as being included in the inventive concept of the present invention.

1. An electronic solenoid air vent comprising:
a nozzle for discharging air in an air vent to the outside; and
a nozzle shut-off configured to control opening and closing of the nozzle,
wherein the nozzle shut-off includes a magnet and a solenoid which spaces the magnet apart from the nozzle in response to a volume of the air in the air vent.

2. The electronic solenoid air vent of claim 1, further comprising:
a cylinder configured to accommodate the magnet;
a rubber packing formed at one end of the magnet; and
an elastic member formed at the other end of the magnet.

3. The electronic solenoid air vent of claim 1, further comprising:
an floater disposed inside the air vent and having a height which varies in response to the volume of air; and
a lead switch configured to transmit a signal which operates the solenoid in response to the height of the floater.

4. The electronic solenoid air vent of claim 3, wherein the lead switch is configured to operate the solenoid on the basis of the height of the floater sensed by the lead switch.

5. The electronic solenoid air vent of claim 3, further comprising a separating sheet connected to the floater and having a surface in which a hole is formed.

6. The electronic solenoid air vent of claim 2, wherein the solenoid is configured to attract the magnet with intensity equal to or greater than an elasticity of the elastic member.

7. The electronic solenoid air vent of claim 1, wherein the air vent is formed so that a side cross-section thereof narrows toward an upper portion thereof.

8. The electronic solenoid air vent of claim 1, further comprising an air discharge manual button configured to manually open and close the nozzle.

9. The electronic solenoid air vent of claim 3, further comprising a power supply configured to supply driving power to the solenoid.

10. The electronic solenoid air vent of claim 1, further comprising a data storage unit configured to store information on an operation of the solenoid.

11. The electronic solenoid air vent of claim 10, wherein the information on the operation includes at least one of information on an operation frequency of the solenoid per hour, information of an operation time, and information of a volume of air discharged per operation time.

12. An electronic solenoid air vent comprising:
a nozzle having a hole for discharging air in an air vent to the outside; and
a nozzle shut-off configured to close the nozzle and, when a volume of air in the air vent is equal to or greater than a first volume, open the nozzle until the volume of air in the air vent is less than a second volume.
